(19) United States
(12) Patent Application Publication
(10) Pub. No.: US 2012/0032039 A1
(43) Pub. Date: Feb. 9, 2012

(54) SUPPORTING BRACKET WITH POSITIONING COLUMN

(76) Inventor: Huey-Hsiu HSIAO, Lu Chou City (TW)

(21) Appl. No.: 13/098,054

(22) Filed: Apr. 29, 2011

Related U.S. Application Data
(62) Division of application No. 12/852,474, filed on Aug. 7, 2010.

(51) Int. Cl. F16M 11/04

(52) U.S. Cl. 248/125.1

(57) ABSTRACT

A supporting bracket has a base and a positioning column. The base is mounted on a bottom bracket to form a stand. The positioning column is attached to the base and has a first positioning piece and a second positioning piece. The first positioning piece is formed on the base and has a first inclined surface and an inclined slot. The second positioning piece is mounted slidably on the first positioning piece and has a second inclined surface and a slide mounted slidably in the inclined slot. Sliding the second positioning piece on the first positioning piece changes an outer diameter of the positioning column so that the positioning column may be fitted into mounting holes of different devices such as audio speakers.

The present invention is a divisional application claiming the benefit of U.S. patent application Ser. No. 12/852, 474 filed on Aug. 7, 2010, the disclosure of which is incorporated herein its entirety.

### BACKGROUND OF THE INVENTION

1. Field of the Invention

The present invention relates to a stand, and more particularly to a supporting bracket that has a positioning column and a telescopic post that has a positioning column. The positioning column selectively changes its outer diameter for positioning purposes.

2. Description of Related Art

An audio speaker is mounted on a stand so that the audio speaker may be set at a desired level. A conventional stand for an audio speaker has a mounting bracket on the top of the stand. The mounting bracket has a mounting post formed on and protruding upward from the mounting bracket so that a mounting hole in the bottom of the audio speaker is engaged with the mounting post to hold the audio speaker on the stand. However, the sizes of the mounting holes of audio speakers are different. Mounting holes that are too small cannot receive the mounting post of the stand, while mounting holes that are too large cannot tightly engage the audio speaker with the stand due to the gap between the mounting hole and the mounting post. Therefore, applicability of the conventional stand is insufficient.

Furthermore, a conventional microphone is mounted on a telescopic stand that is assembled by an inner tube and an outer tube telescopically mounted around the inner tube. Such telescopic configuration further has an adjusting knob and a pressing bolt protruding from the adjusting knob and mounted movably through the outer tube to tightly abut the inner tube. Rotating the adjusting knob selectively tightens or loosens the inner tube in the outer tube so the length of the telescopic stand is changed. However, in some occasions such as conferences and shows, users using a microphone change frequently. Before a next user uses the microphone, the telescopic stand needs to be adjusted by sequentially loosening the adjusting knob, pulling out or pushing in the inner tube to change the length of the telescopic stand and then tightening the adjusting knob. The aforementioned adjustment is complicated, wastes time and easily interrupts or delays the conferences and shows.

To overcome the shortcomings, the present invention provides a supporting bracket with a positioning column and a telescopic post with a positioning column to mitigate or obviate the aforementioned problems.

### SUMMARY OF THE INVENTION

The main objective of the invention is to provide a supporting bracket that has a positioning column and a telescopic post that has a positioning column. The positioning column selectively changes its outer diameter for positioning purposes.

A supporting bracket in accordance with the present invention has a base and a positioning column. The base is mounted on a bottom bracket to form a stand. The positioning column is attached to the base and has a first positioning piece and a second positioning piece. The first positioning piece is formed on the base and has a first inclined surface and an inclined slot. The second positioning piece is mounted slidably on the first positioning piece and has a second inclined surface and a slide mounted slidably in the inclined slot. Sliding the second positioning piece on the first positioning piece changes an outer diameter of the positioning column so that the positioning column may be fitted into mounting holes of different devices such as audio speakers.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a supporting bracket with a positioning column in accordance with the present invention;

FIG. 2 is an exploded perspective view of the supporting bracket in FIG. 1;

FIG. 3 is a cross sectional side view of the supporting bracket in FIG. 1;

FIG. 4 is an operational cross sectional side view of the supporting bracket in FIG. 3;

FIG. 5 is a side view of the supporting bracket mounted on a bottom bracket to form a stand;

FIG. 6 is a cross sectional perspective view of a telescopic post with a positioning column in accordance with the present invention;

FIG. 7 is a cross sectional perspective view of the telescopic post omitting the outer tube;

FIG. 8 is a cross sectional side view of the telescopic post in FIG. 6;

FIG. 9 is an operational cross sectional side view of the telescopic post in FIG. 8 showing the positioning column loosened; and

FIG. 10 is a perspective view of the telescopic post in FIG. 6 mounted on a bottom bracket to form a telescopic stand.

### DETAILED DESCRIPTION OF THE PREFERRED EMBODIMENT

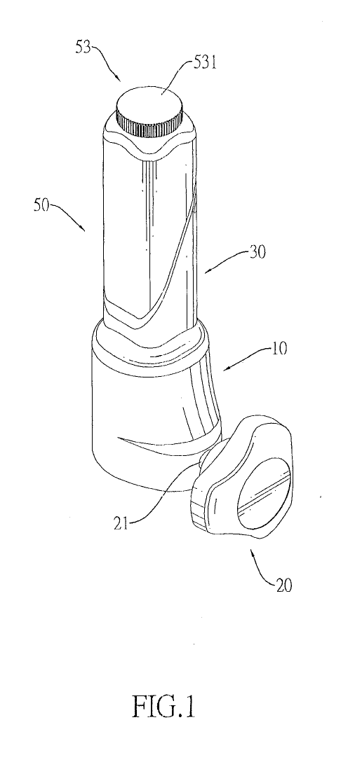

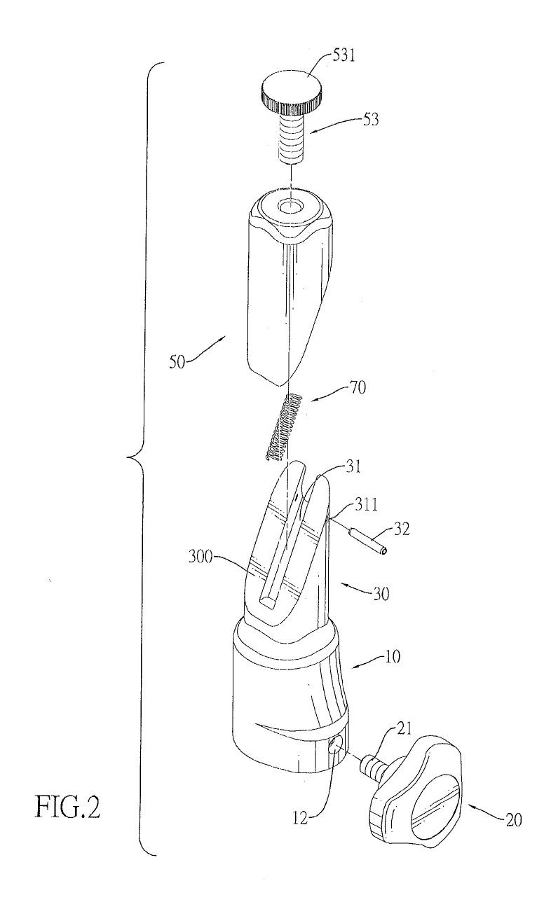

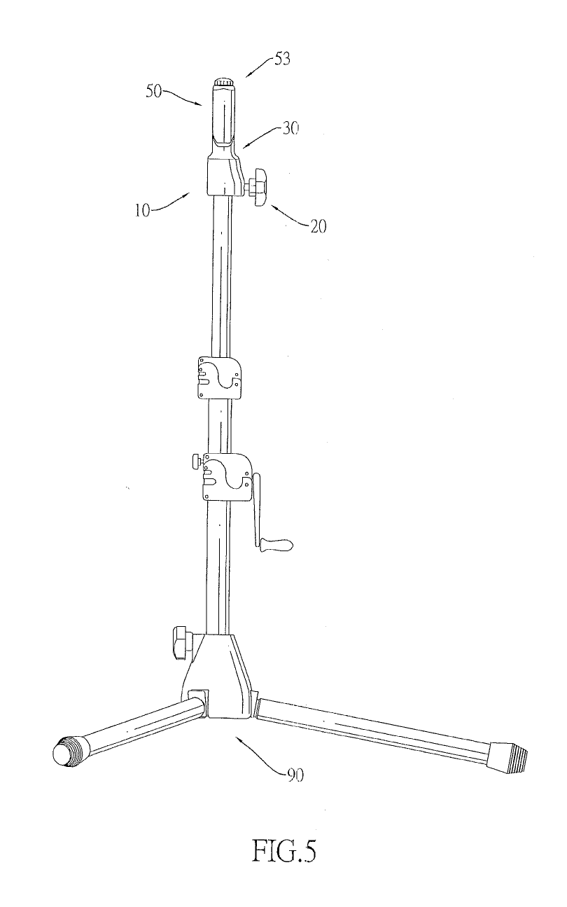

With reference to FIGS. 1 to 5, a supporting bracket in accordance with the present invention comprises a base (10) and a positioning column.

The base (10) may be mounted on a bottom bracket (90) to form a stand. The base (10) has a bottom, a bottom mounting hole (11), a transverse threaded hole (12) and a compression knob (20). The bottom mounting hole (11) is defined in the bottom to receive a top end of a post on the bottom bracket (90). The transverse threaded hole (12) is defined transversely in the base (10) and communicates with the bottom mounting hole (11). The compression knob (20) has a bolt (21) mounted through the transverse threaded hole (12) and extending in the bottom mounting hole (11) to tightly abut the post of the bottom bracket (90).

The positioning column is attached to the base (10) and has a first positioning piece (30) and a second positioning piece (50) and may further have a compression spring (70).

The first positioning piece (30) is formed on the base (10) and has a top, a first inclined surface (300) and an inclined slot (31) and may further have a pin hole (311) and a stopping pin (32). The first inclined surface (300) is formed on the top. The inclined slot (31) is defined in the first inclined surface (300) and has a top end and a closed bottom end. The pin hole (311) is defined through the first positioning piece (30) and communicates with the inclined slot (31). The stopping pin (32) is mounted in the pin hole (311) in the first positioning piece (30) and mounted through the inclined slot (31) near the top end.

The second positioning piece (50) is mounted slidably on the first positioning piece (30) and has a top, a bottom, a second inclined surface (500) and a slide (51) and may further have a threaded hole (52) and an extension bolt (53). The second inclined surface (500) is formed on the bottom and slidably contacts the first inclined surface (300). The slide (51) is formed on and protrudes upward from the second inclined surface (500) and is mounted slidably in the inclined slot (31) so that the second positioning piece (50) is capable of stably sliding on the first positioning piece (30). The slide (51) may selectively abut the stopping pin (32) so that the stopping pin (32) prevents the slide (51) from falling out of the inclined slot (31). The threaded hole (52) is defined in the top of the second positioning piece (50). The extension bolt (53) is mounted in the threaded hole, is capable of extending out to increase a total length of the positioning column and has a top cap (531) formed on the extension bolt (53) and abutting an inner bottom end of a bottom mounting hole of an audio speaker. With extension bolt (53), the total length of the positioning column may vary to adapt to bottom mounting holes of different audio speakers with various lengths.

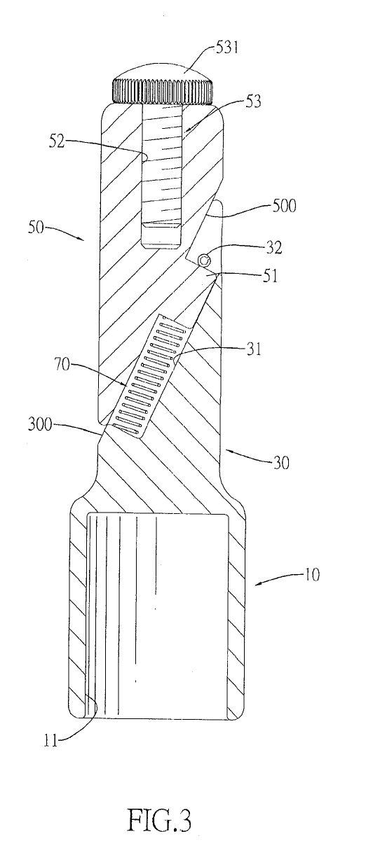

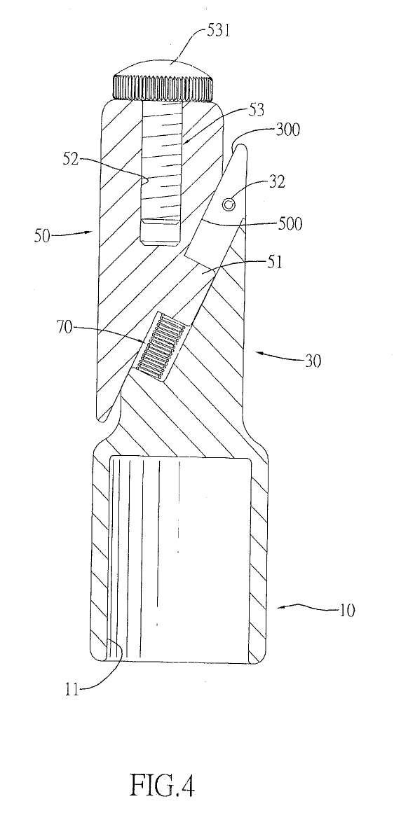

The positioning column assembled by the first and second positioning pieces (30, 50) has an outer diameter that varies depending on the sliding between the first and second positioning pieces (30, 50). When the second positioning piece (50) slides to completely align with the first positioning piece (30), the outer diameter is the smallest, as shown in FIG. 3. When the second positioning piece (50) slides to be staggered relative to the first positioning piece (30), the outer diameter increases, as shown in FIG. 4.

The compression spring (70) is mounted in the inclined slot (31) of the first positioning piece (30) and has two ends. One end of the compression spring (70) abuts the closed bottom end of the inclined slot (31) and the other end abuts and biases the slide (51) of the second positioning piece (50) upward so that the second positioning piece (50) is set in an upper position that minimizes the outer diameter of the positioning column.

When the positioning column is inserted into a bottom mounting hole of an audio speaker and abuts an inner top end of the bottom mounting hole, the second positioning piece (50) slides down relative to the first positioning piece (30) to increase the outer diameter of the positioning column. When the outer diameter is increased to be equal to an inner diameter of the bottom mounting hole, the positioning column completely engages with and fits the bottom mounting hole so that the audio speaker is mounted securely on the stand.

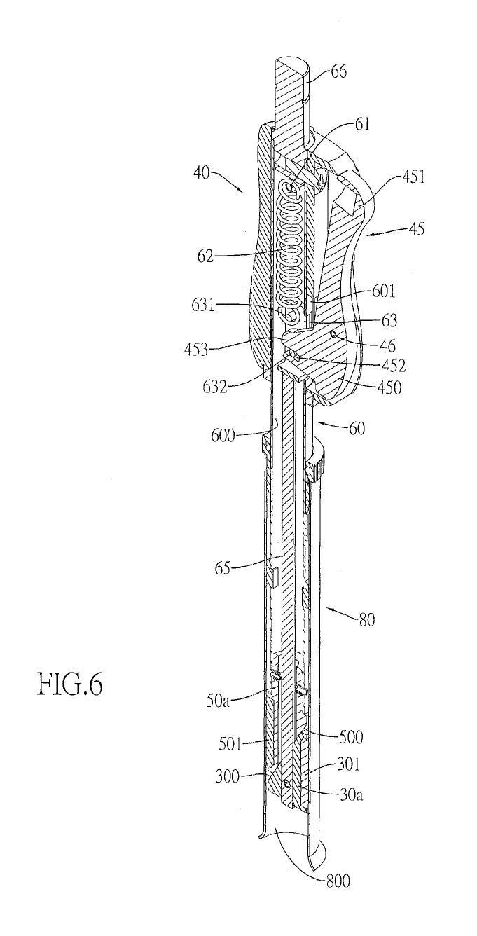

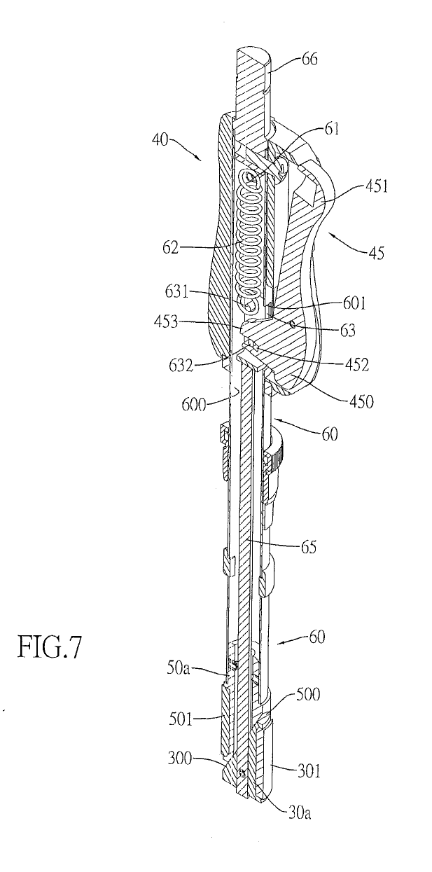

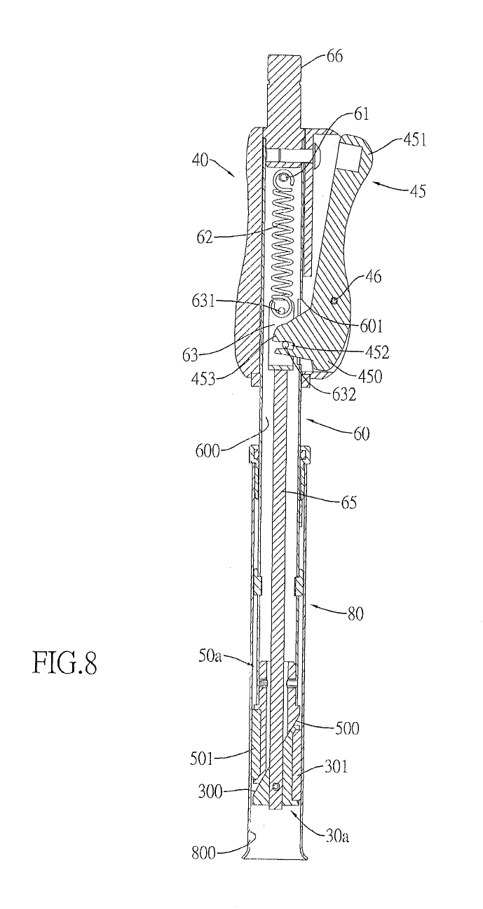

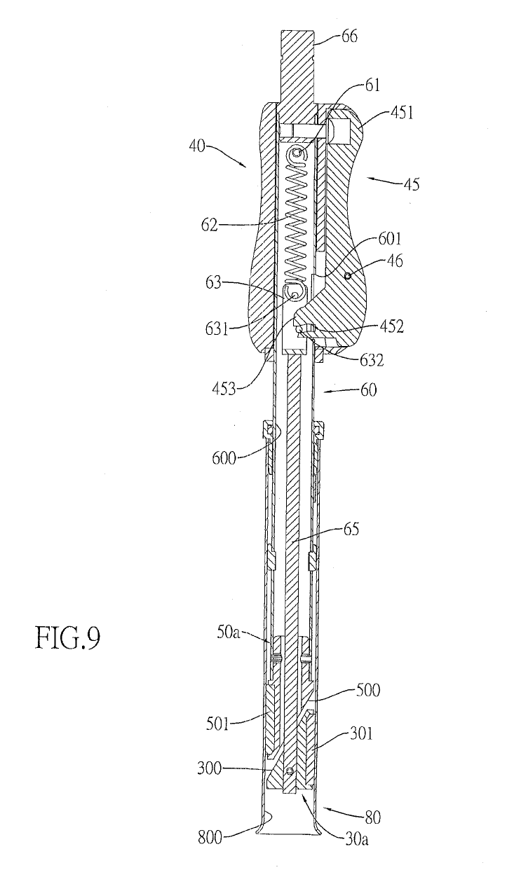

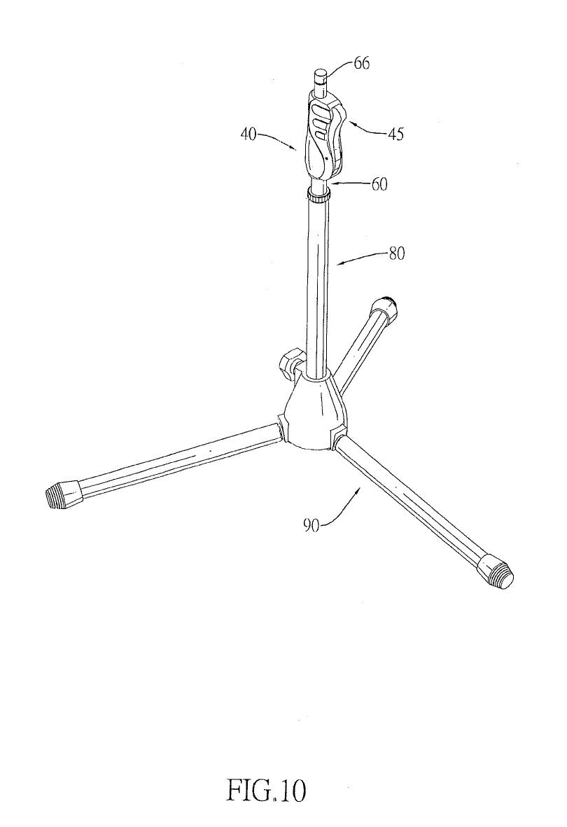

With reference to FIGS. 6 to 10, a telescopic post in accordance with the present invention may be mounted on a bottom bracket (90) to form a telescopic stand to hold a device such as a microphone and comprises a handle (40), an inner tube (60), a tension spring (62), a shaft (65), a press button (45), a positioning column and an outer tube (80).

The inner tube (60) is mounted securely through the handle (40) and has a top end, a bottom end, a central hole (600) and a transverse opening (601) and may further have a mounting cylinder (66). The central hole (600) is defined longitudinally through the inner tube (60), has an inner surface and may further have a mounting pin (61) mounted on the inner surface. The transverse opening (601) is defined transversely through the inner tube (60) and communicates with the central hole (600). The mounting cylinder (66) is mounted on the top end of the inner tube (60) to connect to an external device such as a microphone.

The tension spring (62) has a top end and a bottom end. The top end of the tension spring (62) is mounted securely on the mounting pin (61) in the central hole (600) of the inner tube (60).

The shaft (65) is mounted in the central hole (600) of the inner tube (60) and has a top end, a bottom end and a connecting bracket (63). The connecting bracket (63) is mounted on the top end of the shaft (65), is connected to the bottom end of the tension spring (62), has a driven element (632) and may further have a fastening pin (631). The driven element (632) is formed on the connecting bracket (63) and may be a slide pin. The fastening pin (631) is mounted on the connecting bracket (63) and is mounted on the bottom end of the tension spring (62).

The press button (45) is mounted pivotally on the handle (40) through a pivot pin (46) and has a connecting end (450) and a pressing end (451). The connecting end (450) extends through the transverse opening (601) of the inner tube (60), is connected to the driven element (632) and may have a protrusion (453). The protrusion (453) is formed on and protrudes from the connecting end (450), extends through the transverse opening (601) and has a mounting recess (452) defined in the protrusion (453) and slidably receiving the slide pin. The pressing end (451) is opposite to the connecting end (450) and extends out of the handle (40). Pressing the pressing end (451) moves the connecting end (450) outward and drives the driven element (632) to move down the connecting bracket (63) and the shaft (65) against the resilient force of the tension spring (62).

The positioning column is mounted on the bottom end of the shaft (65) and the bottom end of the inner tube (60) and has a first positioning piece (30a) and a second positioning piece (50a).

The first positioning piece (30a) is mounted on the bottom end of the shaft (65) and has a top, an outer surface and a first inclined surface (300) and may further have a first friction pad (301). The first inclined surface (300) is formed on the top. The first friction pad (301) may be made of rubber and is mounted on the outer surface.

The second positioning piece (50a) is mounted securely on the bottom end of the inner tube, is mounted loosely and slidably around the shaft (65) above the first positioning piece (30a) and has a bottom, an outer surface and a second inclined surface (500) and may further have a second friction pad (501). The second inclined surface (500) is formed on the bottom and selectively slides on and contacts the first inclined surface (300). The second inclined surface (500) tightly abuts the first inclined surface (300) to maximize an outer diameter of the positioning column when the press button (45) is not pressed. When the press button (45) is pressed to drive the shaft (65) to move down, the first inclined surface (300) slides on and even separates from the second inclined surface (500) to decrease the outer diameter of the positioning column. The second friction pad (501) may be made of rubber and is mounted on the outer surface of the second positioning piece (50a).

The outer tube (80) is mounted slidably around the inner tube (60), may be mounted on the bottom bracket (90) and has an assembling hole (800) defined through the outer tube (80) and having an inner surface selectively pressing against the outer surfaces of the first and second positioning pieces (30a, 50a). Preferably, the first and second friction pads (301, 501) tightly abut the inner surface of the assembling hole (800) of the outer tube (80) to maintain the length of the telescopic post when the press button (45) is released. The first and second friction pads (301, 501) loosely abut and even separate from the inner surface of the assembling hole (800) of the outer tube (80) to change the length of the telescopic post when the press button (45) is pressed.

The length of the telescopic post may be adjusted by pressing the press button (45) and retracting or extending the inner tube (60) on the outer tube (80). Releasing the press button (45) positions the inner tube (60) on the outer tube (80) so the overall length of the telescopic post is changed. Therefore, adjusting the length of the telescopic stand is quick and easy.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A supporting bracket comprising:
a base adapted to be mounted on a bottom bracket to form a stand; and
a positioning column attached to the base and having
an outer diameter;
a first positioning piece formed on the base and having
a top;
a first inclined surface formed on the top; and
an inclined slot defined in the first inclined surface and having a top end and a closed bottom end; and
a second positioning piece mounted slidably on the first positioning piece and having
a top;
a bottom;
a second inclined surface formed on the bottom and slidably contacting the first inclined surface; and
a slide formed on and protruding upward from the second inclined surface and mounted slidably in the inclined slot;
wherein sliding the second positioning piece on the first positioning piece changes the outer diameter of the positioning column.

2. The supporting bracket as claimed in claim 1, wherein the positioning column further has a compressing spring mounted in the inclined slot of the first positioning piece and having two ends, one end abutting the closed bottom end of the inclined slot and the other end abutting and biasing the slide of the positioning piece upward.

3. The supporting bracket as claimed in claim 2, wherein
the first positioning piece further has a stopping pin mounted on the first positioning piece and mounted through the inclined slot; and
the slide of the second positioning piece selectively abuts the stopping pin.

4. The supporting bracket as claimed in claim 3, wherein the second positioning piece further has a threaded hole defined in the top of the second positioning piece and an extension bolt mounted in the threaded hole, being capable of extending out and having a top cap formed on the extension bolt.

5. The supporting bracket as claimed in claim 4, wherein the base has
a bottom;
a bottom mounting hole defined in the bottom;
a transverse threaded hole defined transversely in the base and communicating with the bottom mounting hole; and
a compression knob having a bolt mounted through the transverse threaded hole and extending in the bottom mounting hole.
